(19) United States
(12) Patent Application Publication
(10) Pub. No.: US 2009/0012276 A1
(43) Pub. Date: Jan. 8, 2009

(54) Polyhydroxy Hydrogensulfated Trimetallic Nitride Endohedral Metallofullerenes

(76) Inventors: Zhongxin Ge, Blacksburg, VA (US); Harry C. Dorn, Blacksburg, VA (US)

Correspondence Address: BUCHANAN, INGERSOLL & ROONEY PC, POST OFFICE BOX 1404, ALEXANDRIA, VA, 22313-1404, US

(21) Appl. No.: 10/594,429

(22) PCT Filed: Mar. 25, 2005
(86) PCT No.: PCT/US05/10220

§ 371 Date: Feb. 14, 2008

Related U.S. Application Data
(60) Provisional application No. 60/556,431, filed on Mar. 26, 2004.

(51) Int. Cl. C07F 3/00

(52) U.S. Cl. 534/15

(57) ABSTRACT

Polyhydroxy hydrogensulfated trimetallic nitride endohedral metallofullerenes, can be utilized in a number of applications, for example, as proton conductors in electrochemical devices. The presence of encapsulated metal atoms, preferably trivalent metals including lanthanides, rare earths or HIB group metals, polyhydroxy hydrogensulfated trimetallic nitride endohedral metallofullerenes with properties not found in empty-cage polyhydroxy hydrogensulated fullerenes.

### BACKGROUND OF THE INVENTION

The invention is related to the field of carbonaceous nanomaterials, for example, functionalized fullerenes.

Methods of making endohedral metallofullerenes have been previously described, for example in U.S. Pat. No. 6,303,760. “Endohedral metallofullerenes” refers to the encapsulation of atoms inside a fullerene cage network. A family of trimetallic nitride endohedral metallofullerenes can be represented generally as A₃₋ₙXₙN@Cₘ; where A and X are metal atoms, n=0−3, and m can take on even values between about 60 and about 200. All elements to the right of an ® symbol are part of the fullerene cage network, while all elements listed to the left are contained within the fullerene cage network. As an example, Sc₃N@C₈₀ indicates that a Sc₃N trimetallic nitride is situated within a C₈₀ fullerene cage. Methods of making fullerene derivatives having —OH groups or —OSO₃H groups for use in electrochemical devices, such as a fuel cell, have been described, for example, in U.S. Pat. No. 6,495,290. There is a need in the art for modified fullerenes having enhanced properties, for example, hydrogensulfated fullerenes having enhanced thermal stability.

### SUMMARY OF THE INVENTION

A polyhydroxy hydrogensulfated trimetallic nitride endohedral metallofullerene is provided comprising a plurality of hydroxyl groups and a plurality of hydrogensulfate groups covalently bonded to a fullerene encapsulating a trimetallic nitride. In preferred examples, the trimetallic nitride comprises a rare earth element and/or a group IIIB element, or a lanthanide. In most preferred embodiments, the trimetallic nitride comprises metals chosen from among the group consisting of Scandium, Yttrium, Lanthanum, Gadolinium, Holmium, Erbium, Thulium, and Ytterbium.

More particularly ,an endohedral metallofullerene of the formula: A₃₋ₙXₙN@Cₘ(—OH)ᵢ(—OSO₃H)ⱼ is provided; where A and X are metal atoms, n=0−3; mn is an even number between about 60 and about 200; 1<i<m−j; 1<j<m−i. Preferably, A and/or X are a rare earth element and/or a group IIIB element, or are chosen from among the group consisting of Scandium, Yttrium, Lanthanum, Gadolinium, Holmium, Erbium, Thulium, and Ytterbium.

Preferably, a method of hydroxylation and hydrogensulfation of trimetallic nitride endohedral metallofullerene comprises reacting a trimetallic nitride endohedral metallofullerene with NaOH and TBAH in toluene to produce a hydroxylated trimetallic nitride endohedral metallofullerene; and, reacting the hydroxylated trimetallic nitride endohedral metallofullerene into fuming sulfuric.

### BRIEF DESCRIPTION OF THE DRAWINGS

FIG. 1 illustrates a method of making polyhydroxy hydrogensulfated tri metallic nitride endohedral metallofullerenes.

FIG. 2 shows the change in relaxation rate (1/Tᵢ) of water as a function of concentration for Gd₃N@C₈₀(OH)ₓ(OSO₃H)_{y} compared to the commercial MRI contrast agent Magnevist®.

### DETAILED DESCRIPTION OF THEE PREFERRED EMBODIMENTS OF THE INVENTION

Hydrogensulfated fullerenes have been prepared in the past. These materials have found utility as proton conductors in electrochemical devices. However, the materials of the prior art can suffer decomposition at relatively moderate temperatures. It has now been discovered that polyhydroxy hydrogensulfated trimetallic nitride endohedral metallofullerenes have desirable properties not afforded by the fullerene derivatives of the prior art, for example, greater thermal stability. Thus, polyhydroxy hydrogensulfated trimetallic nitride endohedral metallofullerenes, can be utilized, for example, as proton conductors in electrochemical devices. Moreover, the presence of encapsulated metal atoms, preferably trivalent metals including lanthanides, rare earths or IIB group metals, provide polyhydroxy hydrogensulfated trimetallic nitride endohedral metallofullerenes with further properties not found in empty-cage polyhydroxy hydrogensulfated fullerenes. Thus, polyhydroxy hydrogensulfated trimetallic nitride endohedral metallofullerenes can also find utility, for example, as contrast agents for MRI and as tracers in x-ray applications, and as catalysts.

Not wishing to be bound by theory, it is believed that the electrostatic charge distribution of trimetallic nitride endohedral metallofullerenes, having a negative surface potential, provides for greater stability of attached hydrogensulfate groups.

A preferred family of trimetallic nitride endohedral metallofullerenes can be represented generally as A₃₋ₙXₙN@C.; where A and X are metal atoms, n=0−3, and m can take on even values between about 60 and about 200. To form a trimetallic endohedral metallofullerene having a cage size between about 68 carbon atoms and about 80 carbon atoms, the metal atoms are preferably trivalent and have an ionic radius below about 0.095 nm. When m is about 68, the metal atoms preferably have an ionic radius below about 0.090 nm for the A₃N endohedral species. For the AX₂N and A₂XN endohedral species, the larger atomic radius of 0.095 nm for A can be accommodated. As the size of the cage increases, the ionic radius for the metal may increase. Further, A and X may be a rare earth element, a group IIIB element, or the like. Preferably, A or X may be Scandium, Yttrium, Lantbanum, Gadolinium, Holmium, Erbium, Thulium, and Ytterbium.

Methods for making this family of metallofullerenes include using a Kraitschmer-Huffman generator. This type of generator typically has a reaction chamber that can be easily evacuated and charged with a controlled pressure of an inert gas such as helium. The generator holds two electrodes within the reaction chamber and is able to apply a potential across the electrodes to produce an arc discharge. Methods can include mounting a graphite rod, or other source of carbon, that has been filled with a mixture of a metal oxide and graphite in the reaction chamber. The metal oxide contains the metal to be encapsulated in the fullerene cage. The graphite rods are typically cored and filled with a mixture of metal oxide and graphite. The metal oxide may be the oxide of a trivalent metal. Preferably the metal oxide is the oxide of a rare earth metal or a group IIIB metal. Metal oxides may include, but are not limited to, Er₂O₃, Ho₂O₃, Y₂O₃, La₂O₃, Gd₂O₃, Tm₂O₃, or Yb₂O₃. The mixture of metal oxide and graphite may be from about 1% to about 5% metal oxide to graphite by weight. Typically, a 3% metal oxide to graphite loading will produce the desired trimetallic nitride endohedral metallofullerene.

When the encapsulation of more than one type of metal in the fullerene cage is desired, the cored graphite rod is filled with a mixture of metal oxides and graphite. The mixture of metal oxides preferably corresponds to the desired metals and graphite. The metal oxides may be combination of trivalent metals in the form of oxides. Preferably, the metals are rare earth metal oxides or group IIIB metal oxides. The metal oxides may include, but are not limited to, E₂O₃, Ho₂O₃, Y₂O₃, La₂O₃, Gd₂O₃, Tm₂O₃, or Yb₂O₃. The relative portion of each metal oxide may be from a 1% to about 5% metal oxide to graphite. Small amounts of cobalt oxide may be added to the mixture to enhance the formation of fullerenes. The addition of about 1 mg to about 425 mg of cobalt oxide may be added to the mixture. Typically, the addition of between about 75 mg and about 225 mg of cobalt oxide to the mixture will enhance the formation of the endohedral fullerenes.

Once the mixture is loaded into the cored graphite rod, the rod is place in the generator and the reaction chamber is evacuated. Helium can be introduced into the reaction chamber at about 300 torr along with a small amount of nitrogen gas, about 1 to about 3 torr. A dynamic atmosphere ranging from about 300 ml/min to 1250 ml/min helium and about 20 ml/min to about 300 ml/min nitrogen gas may also be utilized. The ratio of helium to nitrogen is not critical. The trimetallic nitride endohedral metallofullerenes will be produced for a wide range of helium to nitrogen ratios, but yield of the metallofullerenes may tend to decrease as the amount of nitrogen approaches the amount of helium.

In order to form the trimetallic nitride endohedral metallofullerene, a source of nitrogen must be introduced into the reaction chamber. The source of nitrogen is preferably a nitrogen containing gas, but may include other nitrogen sources including but not limited to carbon nitrides and metal nitrides where the metal to be encapsulated is in nitride form.

A potential is applied across the electrodes resulting in an arc discharge. The arc discharge consumes the graphite rod and generates a wide range of carbon products generally referred to as soot. Within the soot is a wide range of fullerenes including the trimetallic nitride endohedral metallofullerenes.

Isolation of the trimetallic nitride endohedral metallofullerenes consists of using carbon disulfide or toluene to extract the soluble fullerenes from the soot. All members of the trimetallic nitride endohedral metallofullerenes, Er₃₋ₙScₙN@C₈₀, Ho₃₋ₙScₙN@C₈₀, Y₃₋ₙScₙN@C₈₀, Gd₃₋ₙScₙN@C₈₀ and La₃₋ₙScₙN@C₈₀ where n=0−3, are extractable in carbon disulfide except Yb₃₋ₙScₙN@C₈₀ and Tm₃₋ₙScₙN@C₈₀ (n=0−3).

The carbon disulfide extract is preferably filtered over a plug of glass wool to remove insoluble material. The extract can then be preferably subjected to a multi-stage chromatographic separation. The soluble extract can be separated using an initial chromatographic separation stage that incorporates a pentabromobenzyl column using carbon disulfide as the mobile phase. One such column is available from Phenomenex Co., Torrance, Calif. In the second and third stages, a selective semi-preparative Trident-Tri-DNP (di-nitorphenyl) column (Regis Chemical, Morton Grove, Ill.) may be utilized for isolation of A₃₋ₙXₙ N(C₈₀ with toluene as the solvent. A final separation stage utilizing the pentabromobenzyl column described above using CS₂ as the mobile phase may be used. The mobile phase elution rate is preferably about 2 ml/min. Using this method, optimized as appropriate for specific species, substantially pure A₃₋ₙXₙN@Cₘ can be isolated.

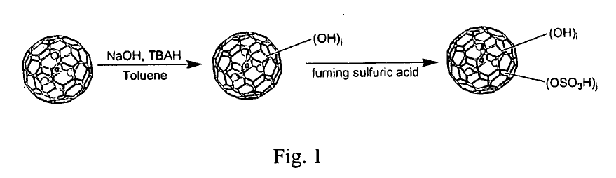

Referring to FIG. 1, trimetallic nitride endohedral metallofullerenes of the formula A₃₋ₙXₙN@Cₘ can be hydroxylated and hydrogensulfated by the example method illustrated. In a first step, A₃₋ₙXₙN@Cₘ can be hydroxylated by reacting with NaOH and tetra butyl ammonium hydroxide in toluene followed by contacting the reacted material with H₂O and H₂O₂. The hydroxylated trimetallic nitride endohedral metallofullerene can be hydrogen sulfated by reacting with fuming sulfuric acid. The result of this process can described using the general formula: A₃₋ₙXₙN@Cₘ (—OH)ᵢ (—OSO₃H)ⱼ; where A and X are metal atoms, n=0−3; m is an even number between about 60 and about 200; 1<i<m−j; 1<j<m−i.

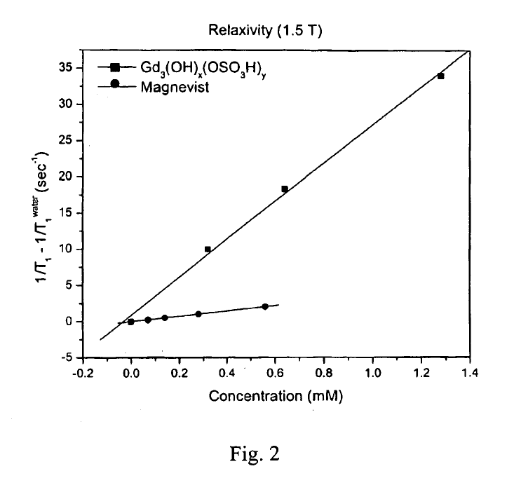

The choice of fullerene cage size and encapsulated metal are also open to the skilled practitioner to choose according to the desired application. For example, one example utility for polyhydroxy hydrogensulfated trimetallic endohedral metallofullerenes is as MRI contrast agents. In MRI, a signal is received from atoms in a magnetic field in response to a pulse of radio waves. The most common atoms used for MRI are hydrogens, particularly the hydrogens of water. Contrast is observed because signal from atoms in different environments decays more or less quickly (relaxes) after a radio pulse. Trivalent metals, for example, can provide effective changes in signal relaxation in an MRI contrast agent application. Accordingly, a method of using polyhdroxy hydrogensulfated trimetallic endohedral metallofullerenes can comprise introducing a composition comprising polyhydroxy hydrogensulfated trimetallic endohedral metallofullerenes into a body prior to or during acquisition of MRI data. The polyhydroxy hydrogensulfated trimetallic endohedral metallofullerenes can provide substantially greater relaxivity than presently used contrast reagents as shown in FIG. 2. As alternative examples, metal atoms such as radioactive atoms can be encapsulated for use in treatment methods or as tracers that can be detected by radiation or x-ray.

### EXAMPLE

Gd₃N@C₈₀ was dissolved in toluene. Several drops of tetrabutylamonium hydroxide and (TBAH) and several drops of 50% NaOH were added. After about 2 hours, the solvent was removed and the mixture dissolved in water followed by the addition of several drops of H₂O₂. This mixture was stirred overnight and separated on a G-25 Sephadex column. The collected solution was dried to produce Gd₃N@C₈₀(OH)ᵢ. Gd₃N@C₈₀(OH)ᵢ was added to fuming sulphuric acid and stirred at room temperature under N₂ for three days. The resulting mixture was precipitated in anhydrous diethyl ether in an ice bath. The precipitates were washed with anhydrous diethyl ether and anhydrous diethyl ether-CH₃CN (2:1) and dried. This procedure was also applied to make other polyhydroxy hydrogensulfated trimetallic nitride endohedral metallofullerenes.

While the invention has been described in detail with reference to preferred embodiments thereof, it will be apparent to one skilled in the art that various changes can be made, and equivalents employed, without departing from the scope of the invention.

What is claimed is:

1. A polyhydroxy hydrogensulfated trimetallic nitride endohedral metallofullerene comprising a plurality of hydroxyl groups and a plurality of hydrogensulfate groups covalently bonded to a fullerene encapsulating a trimetallic nitride.

2. The polyhydroxy hydrogensulfated endohedral metallofullerene of claim 1, wherein the trimetallic nitride comprises a rare earth element and/or a group IIIB element.

3. The polyhydroxy hydrogensulfated endohedral metallofullerene of claim 1, wherein the trimetallic nitride comprises metals chosen from among the group consisting of Scandium, Yttrium, Lanthanum, Gadolinium, Holmium, Erbium, Thulium, and Ytterbium.

4. An endohedral metallofullerene of the formula: A₃₋ₙXₙN@Cₘ(—OH)ᵢ(—OSO₃H)ⱼ; where A and X are metal atoms, n=0−3; m is an even number between about 60 and about 200; 1<i<m−j; 1<j<m−i.

5. The endohedral metallofullerene of claim 4, wherein, A and/or X are arare earth element and/or a group IIIB element.

6. The endohedral metallofullerene of claim 4, wherein A and/or X are chosen from among the group consisting of Scandium, Yttrium, Lanthanum, Gadolinium, Holmium, Erbium, Thulium, and Ytterbium.

7. A method of hydroxylation and hydrogensulfation of trimetallic nitride endohedral metallofullerene comprising,
reacting a trimetallic nitride endohedral metallofullerene with NaOH and TBAH in toluene;
contacting the reacted reacting a trimetallic nitride endohedral metallofullerene with water and hydrogen peroxide to produce a hydroxylated trimetallic nitride endohedral metallofullerene; and,
reacting the hydroxylated trimetallic nitride endohedral metallofullerene with fuming sulfuric to hydrogensulfate the hydroxylated trimetallic nitride endohedral metallofullerene.

8. A polyhydroxylated hydrogensulfated trimetallic nitride endohedral metallofullerene made by the method of claim 7.
